(19) United States
(12) Patent Application Publication
(10) Pub. No.: US 2024/0035326 A1
(43) Pub. Date: Feb. 1, 2024

(54) FLUID DAMPING APPARATUS

(71) Applicant: LARSON MANUFACTURING COMPANY OF SOUTH DAKOTA, LLC, Brookings, SD (US)

(72) Inventors: Michael Kondratuk, Brookings, SD (US); Daniel Schneider, Brookings, SD (US)

(21) Appl. No.: 18/356,483

(22) Filed: Jul. 21, 2023

Related U.S. Application Data
(60) Provisional application No. 63/393,097, filed on Jul. 28, 2022.

(51) Int. Cl. E05F 3/12; E05F 3/10; E05F 3/14

(52) U.S. Cl. CPC E05F 3/12; E05F 3/10; E05F 3/14; E05Y 2900/132; E05Y 2201/266

(57) ABSTRACT

A fluid damping apparatus includes a housing enclosing a chamber retaining a damping fluid, a piston disposed in the housing chamber and movable between a first end position and a second end position, and a variable volume element disposed in the housing chamber having a first size occupying a first volume in the housing chamber. Increased fluid pressure of the damping fluid (e.g., resulting from increased temperature of the fluid damping apparatus and associated expansion of the damping fluid) compresses the variable volume element to a second size occupying a second volume in the housing chamber smaller than the first volume, to permit expansion of the damping fluid, thereby limiting fluid pressure of the damping fluid.

### CROSS-REFERENCE TO RELATED APPLICATION

This application claims priority to and all benefit of U.S. Provisional Patent Application Ser. No. 63/393,097, filed on Jul. 28, 2022, for FLUID DAMPING APPARATUS WITH FLUID EXPANSION AND CONTRACTION COMPENSATING ARRANGEMENTS, the entire disclosure of which is incorporated herein by reference.

### BACKGROUND

Storm, security, and screen door applications present certain challenges for hydraulic door closer products. For example, the temperature range that a closer typically operates within is greater than, for example, an internal prime door closer because of the exposure to varying high and low outside temperatures as well as the potential heat buildup between the prime door and the storm, security, or screen door, often collectively referred to as secondary doors. The heat buildup can be quite substantial and causes the increase in temperature and associated expansion of the hydraulic fluid or hydraulic oil, which may subsequently result in a fluid pressure increase in the sealed closer containing the fluid or oil. The increased pressure often results in fluid or oil leakage due to the intense pressure of the heated fluid. In other environments, contraction or reduction in volume of the hydraulic fluid (e.g., due to extreme low temperatures) may result in insufficient hydraulic fluid within the door closer, which may impact the damping function of the door closer.

### SUMMARY OF THE DISCLOSURE

In an exemplary embodiment of the present disclosure, a fluid damping apparatus includes a housing enclosing a chamber retaining a damping fluid, a piston disposed in the housing chamber and movable between a first end position and a second end position, and a variable volume element disposed in the housing chamber having a first size occupying a first volume in the housing chamber. Increased fluid pressure of the damping fluid (e.g., resulting from increased temperature of the fluid damping apparatus and associated expansion of the damping fluid) compresses the variable volume element to a second size occupying a second volume in the housing chamber smaller than the first volume, to permit expansion of the damping fluid, thereby limiting fluid pressure of the damping fluid.

In another exemplary embodiment of the present disclosure, a fluid damping apparatus includes a housing enclosing a chamber retaining a damping fluid, a piston disposed in the housing chamber and movable between a first end position and a second end position, and a variable volume element disposed in the housing chamber and occupying a first volume in the housing chamber, the variable volume element defining an internal cavity in fluid communication with a vent port in the housing. Increased fluid pressure of the damping fluid compresses the variable volume element to occupy a second volume in the housing chamber smaller than the first volume, to permit expansion of the damping fluid, thereby limiting fluid pressure of the damping fluid.

In another exemplary embodiment of the present disclosure, a fluid damping apparatus includes a housing enclosing a chamber retaining a damping fluid, a piston disposed in the housing chamber and movable between a first end position and a second end position, and a flexible partition disposed in an opening in the housing intersecting the housing chamber, the flexible partition including an outer periphery fixed to an inner periphery of the opening, and a flexible central portion that is deflectable in response in changes in fluid pressure of the damping fluid. Increased fluid pressure of the damping fluid deflects the central portion of the partition away from the housing chamber to permit expansion of the damping fluid, thereby limiting fluid pressure of the damping fluid.

In another exemplary embodiment of the present disclosure, a method of making a fluid damping apparatus includes providing a housing enclosing a housing chamber retaining a piston and a fluid return passage in fluid communication with the housing chamber. The housing chamber and the fluid return passage are filled with a damping fluid at a first temperature below an ambient temperature. The temperature of the damping fluid is increased to the ambient temperature, such that the damping fluid undergoes at least one of thermal expansion into an overflow chamber in fluid communication with the housing chamber, and increased fluid pressure within the housing chamber.

In another exemplary embodiment of the present disclosure, a method of making a fluid damping apparatus includes providing a housing including a housing chamber retaining a piston disposed between a first side of the housing chamber and a second side of the housing chamber, a fluid return passage connecting the first side of the housing chamber to the second side of the housing chamber, and an air capture chamber connected to the second side of the housing chamber. The housing chamber and the fluid return passage are filled with a damping fluid. The housing is oriented such that at least an upper portion of the second side of the housing chamber is angled from a horizontal orientation, with the angled upper portion of the second side of the housing chamber extending to the air capture chamber.

In another exemplary embodiment of the present disclosure, a fluid damping apparatus includes a housing having a housing chamber retaining a damping fluid and a piston disposed between a first side of the housing chamber and a second side of the housing chamber, a fluid return passage connecting the first side of the housing chamber to the second side of the housing chamber, and an air capture chamber connected to the second side of the housing chamber. The second side of the housing chamber includes an upward angled surface feature extending to the air capture chamber to facilitate passage of air into the air capture chamber.

In another exemplary embodiment of the present disclosure, a fluid damping apparatus includes a housing having a housing chamber retaining a damping fluid and a piston disposed between a first side of the housing chamber and a second side of the housing chamber, a fluid return passage connecting the first side of the housing chamber to the second side of the housing chamber, an air capture chamber connected to the second side of the housing chamber, and a bleed passage connecting the fluid return passage to the air capture chamber. The bleed passage is configured to block damping fluid flow while permitting air flow to bleed any trapped air in the fluid return passage to the air capture.

In another exemplary embodiment of the present disclosure, a fluid damping apparatus includes a housing having a housing chamber retaining a damping fluid and a piston disposed between a first side of the housing chamber and a second side of the housing chamber, and a fluid return passage connecting the first side of the housing chamber to the second side of the housing chamber. The fluid return passage is connected with the first side of the housing chamber by a connecting passage at a location below a minimum expected level of any trapped air within the second side of the housing chamber, to prevent the ingress of trapped air into the fluid return passage.

In another exemplary embodiment of the present disclosure, a fluid damping apparatus includes a housing having a housing chamber retaining a damping fluid and a piston disposed between a first side of the housing chamber and a second side of the housing chamber, an overflow chamber disposed above and in fluid communication with the second side of the housing chamber, and a fluid return passage connecting the first side of the housing chamber to the second side of the housing chamber. The fluid return passage connects directly with the overflow chamber, with an upper portion of the overflow chamber being sized and positioned to capture air passing through the fluid return passage, and a lower portion of the overflow chamber extends to the second side of the housing chamber for return of the damping fluid.

### BRIEF DESCRIPTION OF THE DRAWINGS

Further features and advantages of the invention will become apparent from the following detailed description made with reference to the accompanying drawings, wherein:

FIG. 1 is a perspective view of a rotationally activated fluid damping closer;

FIG. 2 is a side view of the closer of FIG. 1;

FIG. 3A is a cross-sectional top view of the closer of FIG. 1;

FIG. 3B is a cross-sectional top view of an alternative embodiment of a closer as defined by FIGS. 1 and 2;

FIG. 3C is a cross-sectional top close up view of the closer as defined by FIG. 3B;

FIG. 4 is a side view of a fluid damping closer;

FIG. 5 is a cross-sectional front view of the closer as defined by FIG. 4;

FIG. 6 is a front view of a fluid damping closer;

FIG. 7 is a cross-sectional side view of the closer as defined by FIG. 6;

FIG. 8 is a side view of a fluid damping closer;

FIG. 9 is a cross-sectional side view of a fluid damping closer assembly including a schematically illustrated externally sealed variable volume element, according to an exemplary embodiment of the present disclosure;

FIG. 9A is an enlarged partial cross-section view of the closer assembly of FIG. 9, with the damping fluid in an elevated pressure condition;

FIG. 9B is an enlarged partial cross-section view of the closer assembly of FIG. 9, with the damping fluid in a reduced pressure condition;

FIG. 10 is a cross-sectional side view of a fluid damping closer assembly including an externally sealed variable volume element, according to another exemplary embodiment of the present disclosure;

FIG. 10A is an enlarged partial cross-section view of the closer assembly of FIG. 10, with the damping fluid in an elevated pressure condition;

FIG. 10B is an enlarged partial cross-section view of the closer assembly of FIG. 10, with the damping fluid in a reduced pressure condition;

FIG. 11 is a cross-sectional side view of a fluid damping closer assembly including an externally sealed variable volume element, according to another exemplary embodiment of the present disclosure;

FIG. 12 is a cross-sectional side view of a fluid damping closer assembly including an externally sealed variable volume element, according to another exemplary embodiment of the present disclosure;

FIG. 13 is a cross-sectional side view of a fluid damping closer assembly including an externally vented variable volume element, according to an exemplary embodiment of the present disclosure;

FIG. 13A is an enlarged partial cross-section view of the closer assembly of FIG. 11, with the damping fluid in an elevated pressure condition;

FIG. 13B is an enlarged partial cross-section view of the closer assembly of FIG. 11, with the damping fluid in a reduced pressure condition;

FIG. 14 is a cross-sectional side view of a fluid damping closer assembly including an externally vented variable volume element, according to an exemplary embodiment of the present disclosure;

FIG. 14A is an enlarged partial cross-section view of the closer assembly of FIG. 14, with the damping fluid in an elevated pressure condition;

FIG. 14B is an enlarged partial cross-section view of the closer assembly of FIG. 14, with the damping fluid in a reduced pressure condition;

FIG. 15 is a cross-sectional side view of a fluid damping closer assembly including an externally vented variable volume element, according to an exemplary embodiment of the present disclosure;

FIG. 15A is an enlarged partial cross-section view of the closer assembly of FIG. 15, with the damping fluid in an elevated pressure condition;

FIG. 15B is an enlarged partial cross-section view of the closer assembly of FIG. 15, with the damping fluid in a reduced pressure condition;

FIG. 16 is an enlarged partial cross-section of a fluid damping closer assembly including an externally vented variable volume element, according to an exemplary embodiment of the present disclosure;

FIG. 17 is a perspective view of a fluid damping closer assembly including a radially deflectable partition, according to an exemplary embodiment of the present disclosure;

FIG. 18 is side cross-sectional view of the closer assembly of FIG. 17;

FIG. 18A is an enlarged partial cross-section view of the closer assembly of FIGS. 17 and 18, with the damping fluid in a normal condition;

FIG. 18B is an enlarged partial cross-section view of the closer assembly of FIGS. 17 and 18, with the damping fluid in an elevated pressure condition;

FIG. 18C is an enlarged partial cross-section view of the closer assembly of FIGS. 17 and 18, with the damping fluid in a reduced pressure condition;

FIG. 19 is a side cross-sectional view of a fluid damping closer assembly including an air trapping overflow chamber;

FIG. 19A is a side cross-sectional view of the closer assembly of FIG. 19, shown in a tilted orientation to capture air from the second side of the housing chamber;

FIG. 20 is a side cross-sectional view of a fluid damping closer assembly including a housing chamber having an angled air channeling upper portion;

FIG. 21 is a side cross-sectional view of a fluid damping closer assembly including an air trapping overflow chamber connected with a fluid return passage by a bleed passage;

FIG. 22 is a side cross-sectional view of a fluid damping closer assembly including a fluid return passage disposed below the housing chamber;

FIGS. 23, 23A, 23B, and 23C illustrate side, end cross-sectional, end, and side cross-sectional views of a fluid damping closer assembly including a fluid return passage having a connecting passage intersecting a medial portion of the second side of the housing chamber;

FIG. 24 is a side cross-sectional view of a fluid damping closer assembly including an air trapping overflow chamber connected with a fluid return passage;

FIG. 25 is a side cross-sectional view of a fluid damping closer assembly including an air trapping overflow chamber connected with a fluid return passage, with the overflow chamber being provided with a pressure displaceable element configured to provide a variable volume for expansion of the damping fluid; and

FIG. 26 is a cross-sectional view of a fluid return passage and fluid return control valve for a fluid damping closer assembly, according to an exemplary embodiment of the present disclosure.

### DETAILED DESCRIPTION

This Detailed Description merely describes exemplary embodiments and is not intended to limit the scope of the claims in any way. Indeed, the invention as claimed is broader than and unlimited by the described embodiments, and the terms used have their full ordinary meaning. For example, while the disclosure describes exemplary embodiments of a hydraulic fluid damping door closer apparatus for secondary doors (e.g., storm door or screen door), one or more of the inventive aspects described herein may additionally or alternatively be applied to actuation damping mechanisms for other types of doors (e.g., appliance doors, cabinet doors), drawers, window units, or other such movable structures, or for thermal expansion/contraction compensating arrangements for other fluid enclosures, such as, for example, tanks and vessels.

The present disclosure contemplates arrangements for compensating for variations in damping fluid volume and/or pressure in a fluid damping apparatus (e.g., door closer assembly), for example, due to thermal expansion or contraction of the damping fluid. According to an exemplary aspect of the present disclosure, one or more features may be provided for varying the internal volume retaining the damping fluid, for example, to avoid over-pressurization and/or leakage of the damping when the damping fluid thermally expands at higher temperatures, while providing sufficient damping fluid in a damping speed controlling fluid return passage for damped door closing movement when the damping fluid thermally contracts at lower temperatures.

The disclosed compensating arrangements may be particularly useful in a hydraulic door closer for a storm, screen, or other secondary door, but may additionally or alternatively provide useful benefits in other closer applications or in other actuation damping mechanisms that are subject to a wide range of temperatures or other varying system conditions.

The incorporation of one or more compensating arrangements within the closer, as described in some of the embodiments and figures, allows for the damping fluid to expand in high temperature situations which controls or limits the pressure build up and eliminates the fluid leakage condition associated with high internal fluid pressures. in addition to the expansion due to high temperature, the compensating arrangements may also provide a benefit in cold temperatures by maintaining a prescribed fluid volume or fluid fill level such that the fluid fill level never becomes too low during cold temperature and fluid contraction resulting from the cold temperature. This is accomplished by having a minimum fluid amount maintained so when the fluid or oil contracts, there is sufficient fluid volume in the closer at the predetermined low temperature requirement, for example, to adequately dampen biased movement (e.g., spring-biased movement) of the piston (e.g., as the door closes).

Some benefits of embodiments showing compensating arrangements described herein include that the damping fluid pressure and fluid level are maintained to a pressure which prevents leakage and provides a consistent fluid operating level ensuring proper closer performance at the potential temperature extremes (e.g., experienced by storm and screen doors).

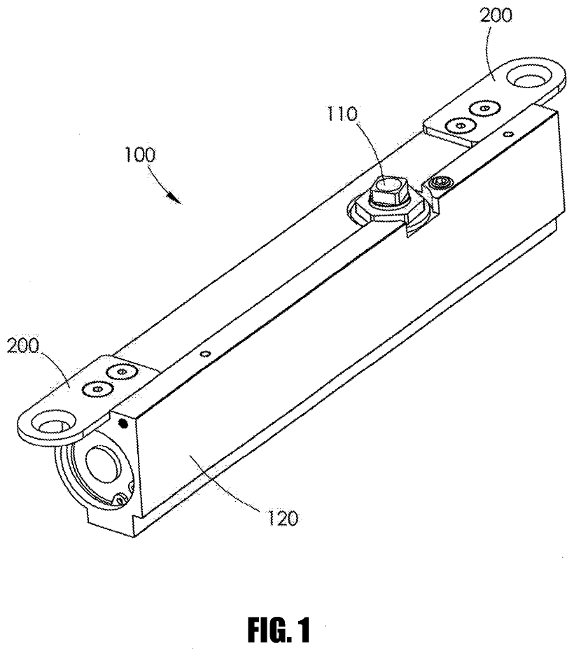

Referring to FIG. 1, the generalized configuration of a rotationally activated fluid damping apparatus 100 is illustrated. While the fluid damping apparatus 100 may be adapted to accommodate a variety of applications, in the illustrated embodiment, the fluid damping apparatus 100 is configured to function as a door actuation damping door closer. In the assembled state, the fluid damping door closer is comprised of a housing 120, a pinion 110 to which an arm (not shown) is typically attached to transfer angular torque from the closer to the door, and mounting tab(s) 200 to affix the closer to the door or a door frame.

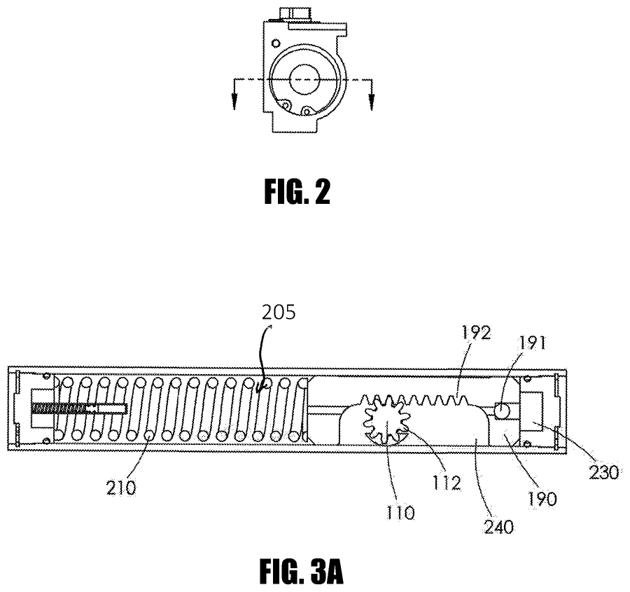

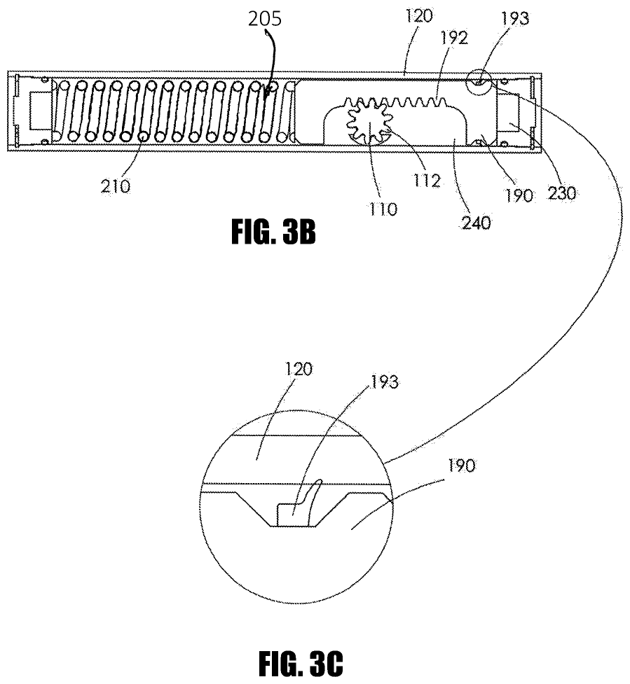

Referring to FIG. 3A, which is a cross-sectional top view of the closer as defined by FIG. 2, the exemplary arrangement includes a piston 190 with a check valve 191, a piston biasing element (e.g., compression spring 210, as shown), and a pinion 110 disposed within a housing chamber 205 of the housing 120. Also within the housing chamber 205 is a damping fluid, typically an oil or oil derivative, which is used to dampen the speed of the piston, as moved by forces applied by the compressed biasing spring 210 during swinging or pivoting movement of the door. In other embodiments, other piston biasing elements may be used, including, for example, tension springs, torsion springs, and elastically compressible or expandable elastomers, foams, and balloon elements.

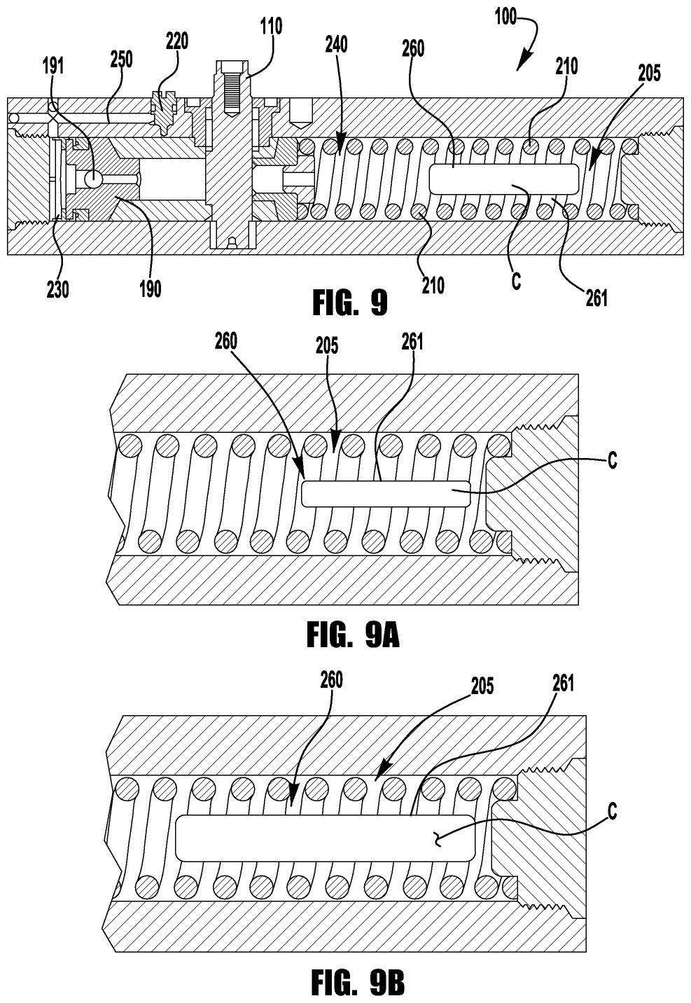

In the illustrated arrangement, as the piston 190 moves transversely within the housing chamber, the pinion 110 rotates as a result of the engagement between the teeth 192 of the piston and the teeth 112 of the pinion, causing the closer arm (not shown) to rotate and pull the door closed. When the closer arm is rotated as the door is opened, the pinion gear teeth 112 apply a force to the piston gear teeth 192 to move the piston 190 in a direction that further compresses the biasing spring 210 and causes fluid to flow from a second side of the housing chamber (i.e., portion of the housing chamber retaining the spring 210 or other such biasing feature) through the one-way check valve 191 to a first side (i.e., separated from the second side by the piston 190) of the housing chamber 205. When the door is released to dose, the compressed biasing spring 210 urges the piston toward a first side 230 of the housing chamber 205, opposite a second side 240 of the housing chamber. Fluid on the first side 230 of the housing chamber 205 is displaced but is prevented from flowing back through the check valve 191 so that fluid flows through a fluid return passage 250 to the second side 240 of the housing chamber. As shown in FIG. 9 and described in greater detail below, the fluid return passage 250 may be provided with a fluid return control or speed control device 220 (e.g., a valve, perforated membrane, filter/screen, orifice restriction) to limit or control the flow rate of damping fluid to the second side 240 of the housing chamber 205, for example, to increase or decrease the damping effect (e.g., closing speed) on the door (or other associated movable structure).

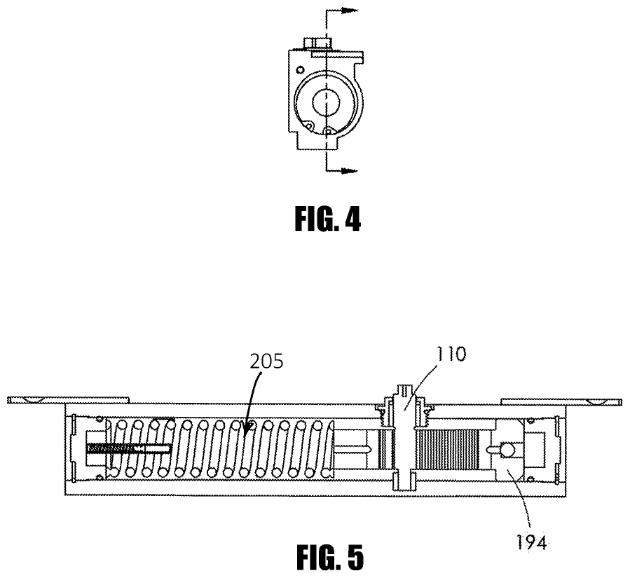

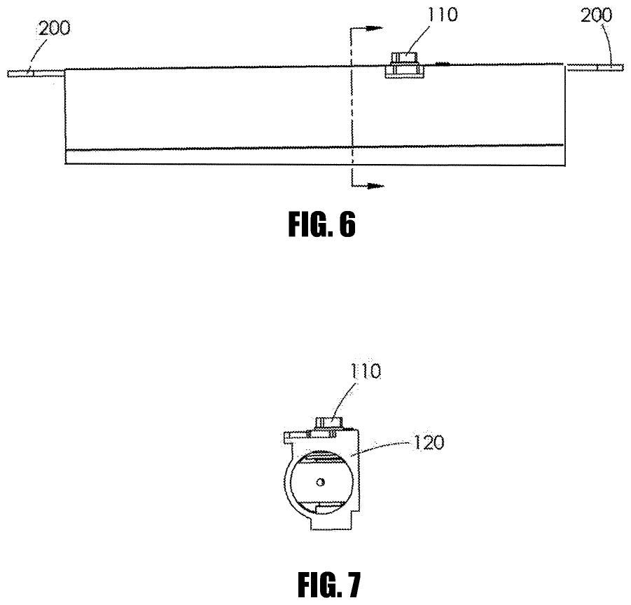

Additional cross-sectional, front and side views of the closer of FIG. 1 are illustrated in FIGS. 4-7. FIG. 5 is a cross-section front view of the closer as defined by FIG. 4 illustrating pinion 110 and the sealing portion of closer piston 194. FIG. 6 is a front view of the closer defining the cross section for FIG. 7 and illustrates pinion 110 and mounting tabs 200 (e.g., for mounting the fluid damping apparatus to a door). FIG. 7 is a cross section defined by FIG. 6 and illustrates pinion 110 and housing 120.

A closer may be provided with a chamber, cavity, or other such interior space configured to receive an overflow or expanded volume of damping fluid, for example, to avoid excessive over-pressurization of the damping fluid, and resulting fluid leakage from the closer. The interior space for expanded or overflow damping fluid may take a variety of forms, including, for example, a chamber or passage offset from the housing chamber, or a deformable or deflectable element within the housing chamber or within an offset passage/chamber. Exemplary embodiments of damping fluid overflow space arrangements are described in co-owned U.S. Pat. Nos. 10,370,885, 11,105,134, and 11,105,135, the entire disclosures of each of which are incorporated herein by reference.

According to an exemplary aspect of the present disclosure, a fluid damping apparatus may be provided with a collapsible, compressible, or other such variable volume element within the housing chamber (e.g., sleeved within the biasing spring), that is collapsed, compressed, or otherwise affected by damping fluid pressure within the housing chamber, to reduce the external volume or size of the variable volume element and correspondingly increase a net volume within the housing chamber occupied by the damping fluid. This expanded damping fluid volume is sufficient to maintain a limited or controlled fluid pressure within the housing chamber, thereby maintaining a desired maximum fluid pressure selected, for example, to provide a desired degree of piston stroke damping and/or to minimize or prevent fluid leakage from the closer.

Many different types of variable volume element may be utilized. In one such arrangement, as shown schematically in FIGS. 9, 9A, and 9B, an externally sealed variable volume enclosure 260 may be disposed within the housing chamber 205 of a door closer 100, and may include one or more flexible outer wall portions 261 biased to a first or normal position under normal closer conditions (e.g., temperatures between about 50° F.-100° F.). The normal biased positions of the one or more wall portions 261 may be maintained, for example, by a compressible fluid C (e.g., air, carbon dioxide) within the enclosure 260 exerting outward pressure on the wall portions, and/or by a lower energy position of the flexible wall portions, for example, as mechanically biased by an internal spring component or an integral/inherent elasticity of the wall portion. Under normal (e.g., ambient temperature) conditions, the equilibrium between the damping fluid pressure and the compressible fluid pressure (along with any outward biasing forces of the enclosure wall portions 261) maintain the variable volume enclosure 260 in a first volume condition, as shown in FIG. 9.

When the damping fluid in the housing chamber 205 expands (e.g., due to temperature increases above about 100° F.), the resulting increase in compressive forces of the damping fluid on the enclosure wall portions 261 results in inward deflection of the wall portions against any outward biasing, due to compression of the compressible fluid C in the enclosure 260 and/or inward flexing of the outwardly biased wall portions, either to a maximum deflected position or until a new pressure equilibrium is reached at a smaller, second volume condition of the variable volume enclosure 260, as shown in FIG. 9A. The resulting increase in the net volume in the housing chamber for the damping fluid may serve to limit or control fluid pressure of the damping fluid, for example, to prevent leakage of damping fluid from the closer housing.

When the damping fluid in the housing chamber 205 contracts (e.g., due to temperature decreases below about 50° F.), the resulting reduction in compressive forces of the damping fluid on the enclosure wall portions 261 results in outward deflection of the wall portions against these reduced compressive forces, due to a net positive pressure of the compressible fluid C in the enclosure 260 and/or further outward flexing of the outwardly biased wall portions, either to a maximum deflected position or until a new pressure equilibrium is reached at a larger, third volume condition of the variable volume enclosure 260, as shown in FIG. 9B. The resulting decrease in the net volume in the housing chamber for the damping fluid may serve to maintain a desired fill level of the damping fluid within the housing chamber.

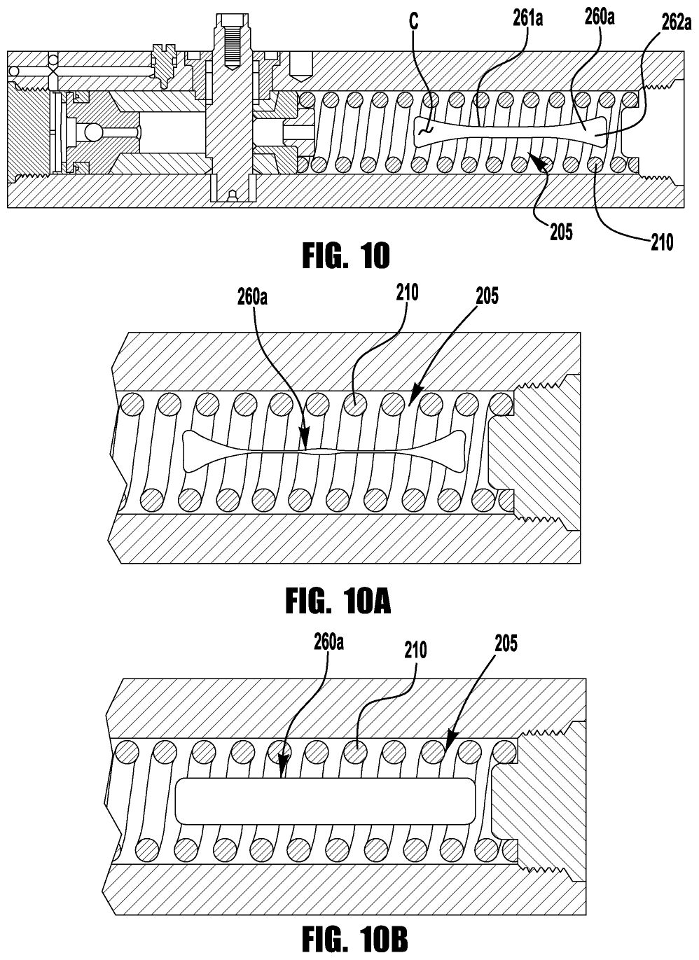

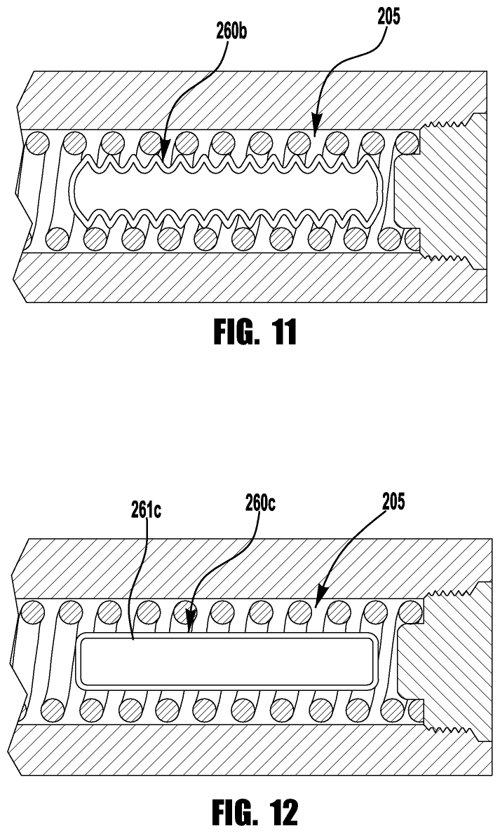

The variable volume element may take a wide variety of forms. As one example, as shown in FIGS. 10, 10A, and 10B, a flexible enclosure 260a may include a flexible surrounding wall portion 261a defining an interior cavity 262a retaining a compressible fluid C, with the enclosure 260a being radially compressible (e.g., to a flattened condition) when the damping fluid in the housing chamber 205 expands (FIG. 10A), and being radially expandable when the damping fluid in the housing chamber 205 contracts (FIG. 10B). The enclosure 260a may be provided in a variety of suitable materials, including, for example, flexible metal materials such as thin-walled steel or aluminum, plastic materials such as polyurethane or polyvinyl chloride (PVC), and/or elastomeric materials such as buna-nitrile and fluoro-elastomer, or elastomer coated fabrics. While any suitable shape may be utilized, in some embodiments, the surrounding wall of the enclosure may be configured to limit radial expansion or to expand and/or contract primarily in the axial direction (i.e., in the direction of the central axis of the surrounding spring), for example, to avoid interference with, or wear against, the surrounding spring. In one such exemplary embodiment, as shown in FIG. 11, the enclosure may be an accordion shaped or bellow-type bladder 260b providing for expansion and contraction in the axial direction. In still other embodiments, the enclosure may be provided with one or more rigid portions and one or more flexible portions, for example, to control or limit the extent or direction of expansion/contraction of the enclosure.

In other exemplary embodiments, as shown in FIG. 12, the variable volume element may include an elastically compressible block 260c of material (e.g., open cell foam, closed cell foam) that is compressible to a smaller exterior size or volume when the damping fluid in the housing chamber 205 expands, and/or to a larger exterior size or volume when the damping fluid in the housing chamber 205 contracts. The variable volume block 260c may be provided with a fluid sealant (e.g., elastomeric) coating 261c to prevent absorption of damping fluid into the block.

According to another exemplary embodiment of the present disclosure, a variable volume enclosure extending into the housing chamber of a fluid damping apparatus may be vented to atmosphere, for example, through a vent port in the housing intersecting the housing chamber. The variable volume enclosure may include a flexible wall portion that may be collapsed, compressed, or otherwise affected by damping fluid pressure within the housing chamber, to expel air or other fluid within the enclosure through the vent, and reduce the volume or size of the variable volume enclosure and correspondingly increase a net volume within the housing chamber occupied by the damping fluid. This expanded damping fluid volume is sufficient to maintain a limited or controlled fluid pressure within the housing chamber, thereby maintaining a desired maximum fluid pressure selected, for example, to provide a desired degree of piston stroke damping and/or to minimize or prevent fluid leakage from the closer.

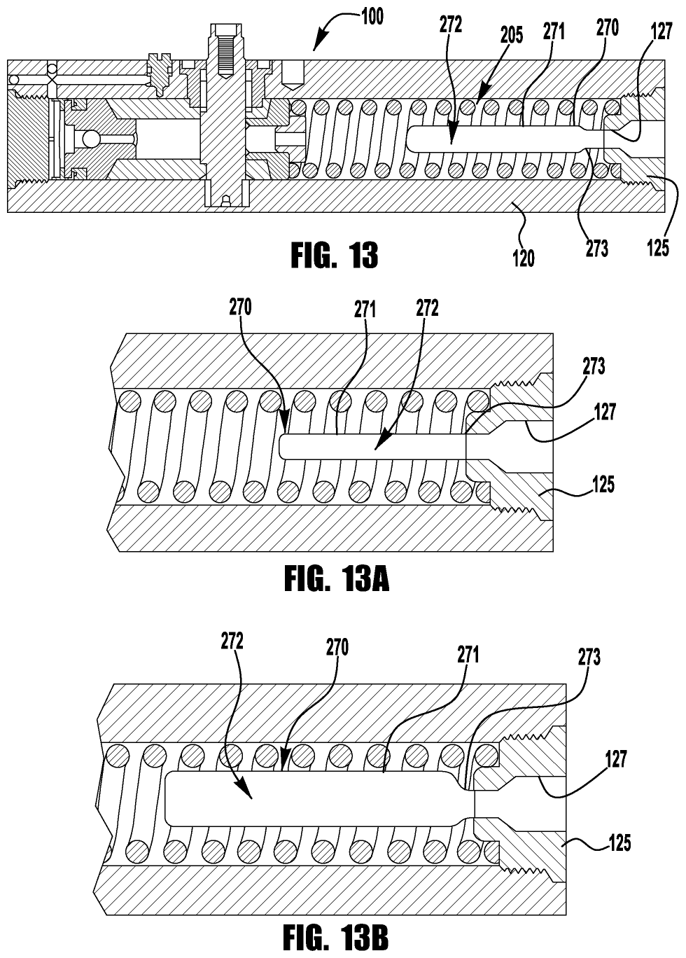

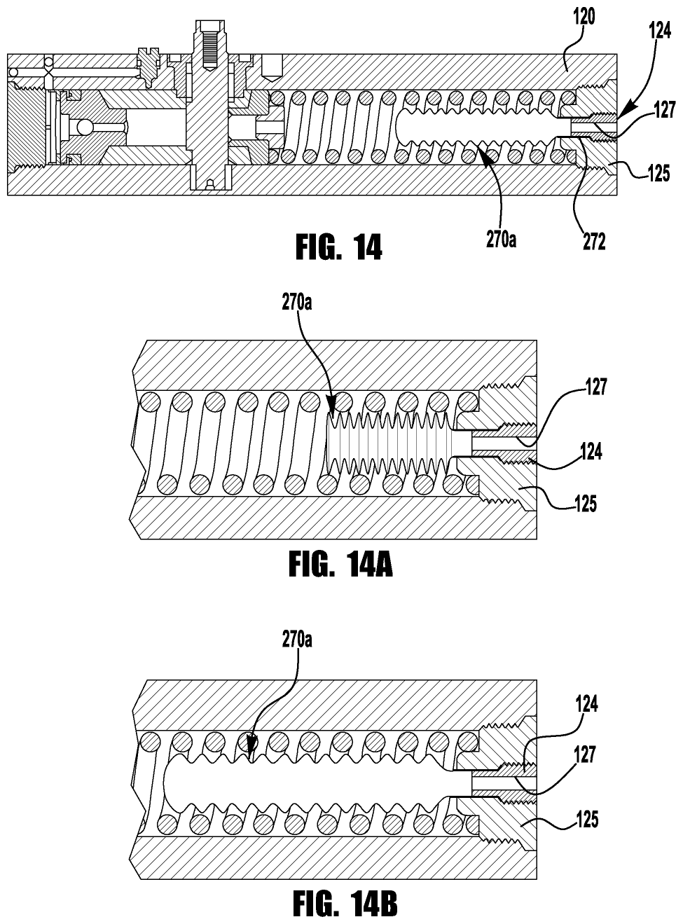

Many different types of variable volume enclosures may be utilized. In one such arrangement, as shown schematically in FIGS. 13, 13A, and 13B, a variable volume enclosure 270 may be disposed within the housing chamber 205 of a door closer 100, and may include a fixed end portion 273 secured to the housing 120 over a vent port 127 in the housing. In the illustrated embodiment, the fixed end portion 273 is secured over a vent port 127 in a sealed end cap portion 125 of the housing 120. The fixed end portion of the enclosure may be secured (e.g., fastened, clamped, welded) over a housing vent port at a variety of locations, including, for example, at the end portion of the housing or on the cylindrical longitudinal side portion of the housing. In an exemplary embodiment, as shown in FIG. 14, the fixed end portion 273 may be captured between a conduit fitting 124 (which defines the vent port 127) and a threaded bore in the end cap 125 portion.

The wall portions 271 of the enclosure 270 define an interior cavity 272 in fluid communication with the vent port 127, and are biased to a first or normal position under normal closer conditions. The normal biased positions of the one or more wall portions 271 may be maintained, for example, by a lower energy or biased position of the flexible wall portions, for example, as mechanically biased by an internal spring component or an integral/inherent elasticity of the wall portion. Under normal (e.g., ambient temperature) conditions, the biased condition of the enclosure 270 maintains the variable volume enclosure in a first volume condition, as shown in FIG. 13.

When the damping fluid in the housing chamber 205 expands (e.g., due to temperature increases), the resulting increase in compressive forces of the damping fluid on the enclosure wall portions 271 results in inward deflection of the wall portions against any outward biasing, and expulsion of air from the enclosure through the vent port 127, due to inward flexing of the outwardly biased wall portions, either to a maximum deflected position or until a new pressure equilibrium is reached at a smaller, second volume condition of the variable volume enclosure 270, as shown in FIG. 13A. The resulting increase in the net volume in the housing chamber for the damping fluid may serve to limit or control fluid pressure of the damping fluid, for example, to prevent leakage of damping fluid from the closer housing.

When the damping fluid in the housing chamber 205 contracts (e.g., due to temperature decreases), the resulting reduction in compressive forces of the damping fluid on the enclosure wall portions 271 results in outward deflection of the wall portions against these reduced compressive forces, and ingress of atmospheric air into the enclosure through the vent port 127, due to further outward flexing of the outwardly biased wall portions either to a maximum deflected position or until a new pressure equilibrium is reached at a larger, third volume condition of the variable volume enclosure 270, as shown in FIG. 13B. The resulting decrease in the net volume in the housing chamber for the damping fluid may serve to maintain a desired fill level of the damping fluid within the housing chamber.

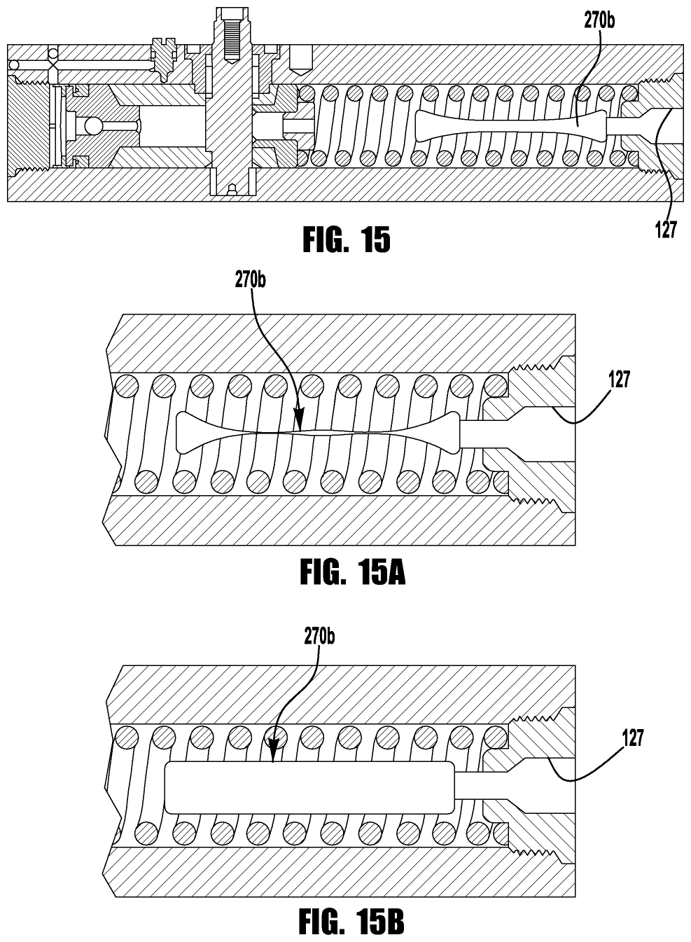

The enclosure 270 may be provided in a variety of suitable materials, including, for example, flexible metal materials such as thin walled steel or aluminum, plastic materials such as polyurethane or polyvinyl chloride (PVC), and/or elastomeric materials such as buna-nitrile and fluoro-elastomer, or elastomer coated fabrics. While any suitable shape may be utilized, in some embodiments, the surrounding wall of the enclosure may be configured to limit radial expansion or to expand and/or contract primarily in the axial direction (i.e., in the direction of the central axis of the surrounding spring), for example, to avoid interference with, or wear against, the surrounding spring. In one such exemplary embodiment, as shown in FIG. 14, the enclosure may be an accordion shaped or bellows-type bladder 270a providing for contraction (FIG. 14A) and/or expansion (FIG. 14B) in the axial direction. In another exemplary embodiment, as shown in FIG. 15, the enclosure 270b may be provided as a radially collapsible/expandable enclosure providing for contraction (FIG. 15A) and/or expansion (FIG. 15B) in the radial direction.

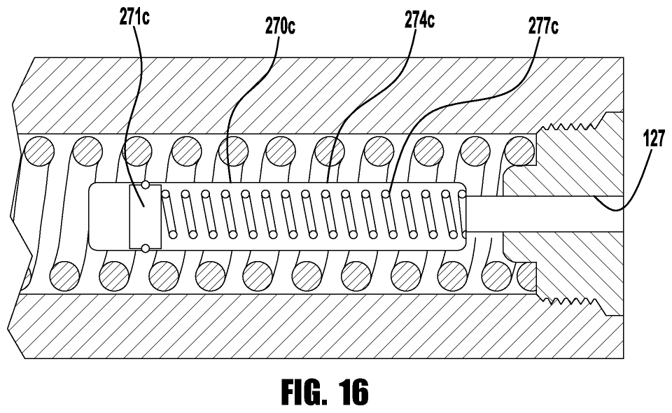

In still other embodiments, the enclosure may be provided with one or more rigid portions and one or more flexible portions, for example, to control or limit the extent or direction of expansion/contraction of the enclosure. As one example, as shown in FIG. 16, a variable volume enclosure 270c may include a rigid tubular element 274c secured in the housing chamber 205 over the vent port 127 in the housing 120, with a spring biased piston 271c defining an inner end wall of the enclosure. When the damping fluid in the housing chamber 205 expands, the resulting increase in compressive forces of the damping fluid on the piston 271c results in inward deflection of the piston against the piston spring 277c, and expulsion of air from the enclosure through the vent port 127, either to a maximum deflected position or until a new pressure equilibrium is reached at a smaller, second volume condition of the variable volume enclosure 270c. When the damping fluid in the housing chamber 205 contracts, the resulting reduction in compressive forces of the damping fluid on the piston 271c results in outward deflection of the piston by the piston spring against these reduced compressive forces, and ingress of atmospheric air into the enclosure through the vent port 127, either to a maximum deflected position or until a new pressure equilibrium is reached at a larger, third volume condition of the variable volume enclosure 270c.

According to another exemplary embodiment of the present disclosure, a net volume in the housing chamber for the damping fluid may be varied by a flexible partition (e.g., membrane or diaphragm) having an outer periphery fixed to an inner periphery of an opening in the housing, intersecting the housing chamber, and a flexible central portion that is deflectable in response in changes in fluid pressure of the damping fluid. The flexible central portion may be deflected, expanded, or otherwise deformed in an outward (i.e., relative to the housing chamber) direction by an increased damping fluid pressure within the housing chamber, to increase a net volume within the housing occupied by the damping fluid. This expanded damping fluid volume is sufficient to maintain a limited or controlled fluid pressure within the housing chamber, thereby maintaining a desired maximum fluid pressure selected, for example, to provide a desired degree of piston stroke damping and/or to minimize or prevent fluid leakage from the closer.

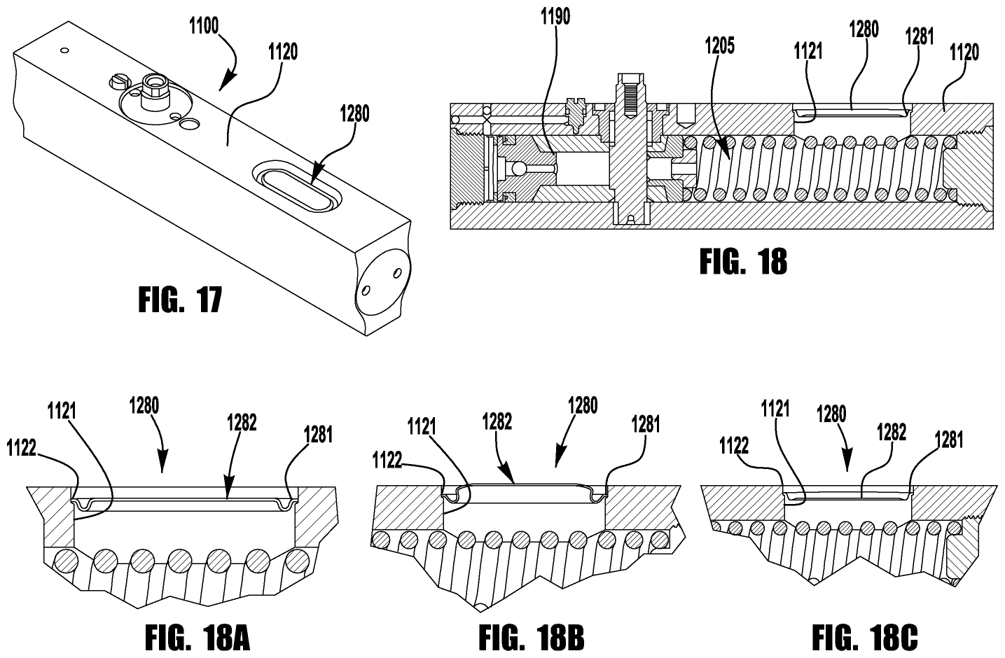

FIGS. 17 and 18 illustrate an exemplary door closer 1100 including a housing 1120 enclosing a housing chamber 1205 retaining a damping fluid and a closer piston 1190 disposed in the housing chamber and movable between a first end position and a second end position. A flexible partition 1280 is disposed in an opening 1121 in the housing 1120 intersecting the housing chamber 1205. The flexible partition 1280 including an outer periphery 1281 fixed to an inner peripheral shoulder 1122 of the opening 1121, and a flexible central portion 1282 that is deflectable in response in changes in fluid pressure of the damping fluid.

When the damping fluid in the housing chamber 1205 expands (e.g., due to temperature increases), the resulting increase in compressive forces of the damping fluid on the partition 1280 causes an outward deflection of the central portion 1282 of the partition away from a low energy or biased position, either to a maximum deflected position of the partition or until a new pressure equilibrium is reached at an outward deflected position of the partition, as shown in FIG. 18B. The resulting increase in the net volume in the housing chamber for the damping fluid may serve to limit or control fluid pressure of the damping fluid, for example, to prevent leakage of damping fluid from the closer housing.

When the damping fluid in the housing chamber 1205 contracts (e.g., due to temperature decreases), the resulting reduction in compressive forces of the damping fluid on the partition 1280 may (but need not) result in inward deflection of the central portion 1282 of the partition toward a low energy or biased position, either to a minimum deflected position of the partition or until a new pressure equilibrium is reached at an inward deflected position of the partition, as shown in FIG. 18C. The resulting increase in the net volume in the housing chamber for the damping fluid may serve to limit or control fluid pressure of the damping fluid, for example, to prevent leakage of damping fluid from the closer housing.

The partition may take a wide variety of forms, including, for example, a flexible metal, plastic, or elastomeric diaphragm, membrane, or film that is welded, clamped or fastened into or over the opening 1121 in the housing 1120.

Referring back to FIG. 9, the damping fluid may be regulated by a fluid return control device 220 (e.g., a valve, perforated membrane, filter/screen, orifice restriction), which controls the flow of damping fluid from the first side 230 of the housing chamber 205 to the second side 240 of the housing chamber. The biasing spring 210 in this embodiment is under compression when assembled within the closer. The spring 210 exerts a biasing load on the piston 190, which is in the neutral state as illustrated, and is balanced within the housing resulting in no torque at the pinion 110. When a closer arm (not shown) is attached to the pinion 1110 and rotated as the door is opened, the pinion gear teeth apply a force to the piston gear teeth to move the piston 190 in a direction that further compresses the spring and causing damping fluid to flow from the second side of the housing chamber through the one-way check valve 191 to the first side of the housing chamber. When the door is released to close, the biasing spring 210 urges the piston 190 toward the first side 230 of the housing chamber. Damping fluid on the first side of the housing chamber is displaced and flows through the fluid return passage 250 and fluid return control device 220 to the second side 240 of the housing chamber. In some embodiments, the fluid return control device 220 may be adjustable (e.g., a user adjustable valve) to control flow rate of the damping fluid.

The relative viscosity of the damping fluid serves to further limit flow rate of the damping fluid through the fluid return passage 250 and the fluid return control device 220. When air is drawn into the fluid return passage 250, for example, due to insufficient filling of the housing chamber with damping fluid, and/or contraction of the damping fluid in cold temperatures, the increased flow rate of this less viscous air past the fluid return control device, relative to the damping fluid, can result in an undesirable faster rotation of the pinion 110 and closing of the corresponding door. According to other exemplary aspects of the present disclosure, arrangements for eliminating the retention of air in the fluid return passage are also contemplated.

In an exemplary arrangement, a damping fluid may be supplied to the housing 120 at a first, lower than ambient temperature (e.g., temperatures below about 0° F., or about −30° F.), such that as the temperature of the damping fluid increases to a second, ambient temperature, the damping fluid expands to sufficiently fill the housing chamber 205 and fluid return passage 250.

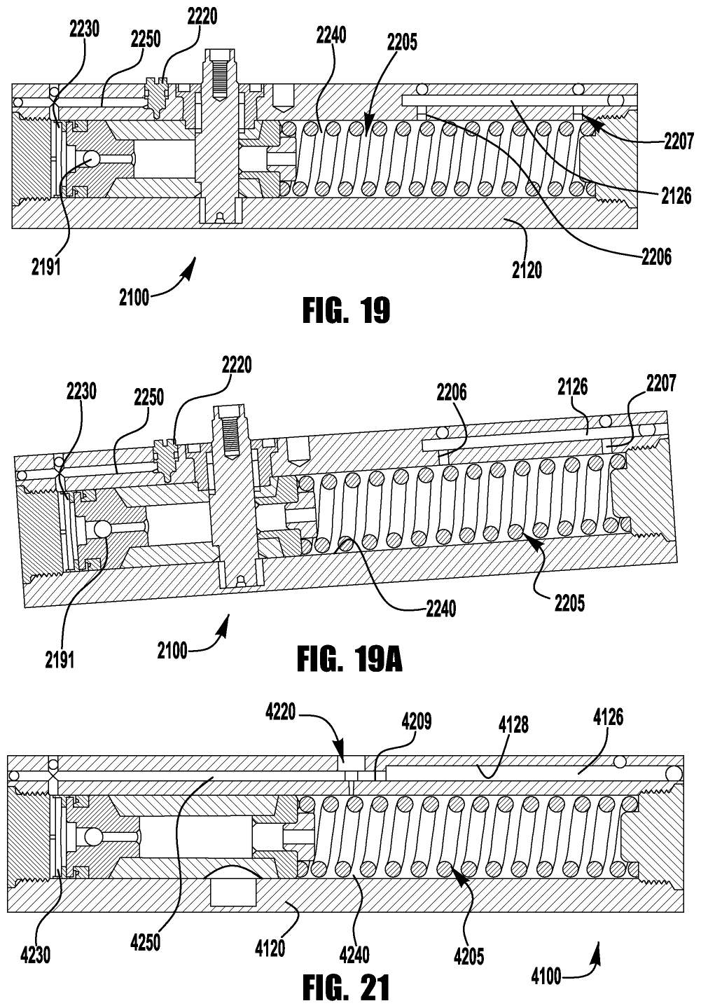

In another exemplary arrangement, as shown in FIG. 19, a closer assembly 2100 includes an air capturing overflow chamber 2126 in fluid communication with the second side 2240 of the housing chamber 2205 that may be sized and positioned to trap any air retained within the housing, such that fluid passing through the check valve during the door opening operation is limited to the damping fluid. As shown, the overflow chamber 1226 may be connected with the second side 2240 of the housing chamber 2205 by axially spaced first and second fluid ports 2206, 2207 to facilitate air ingress into the overflow chamber and damping fluid drainage into the housing chamber.

In some such applications, air trapped in the housing 2120 may be urged into the air capturing overflow chamber 2126 by tilting the closer assembly 2100, as shown in FIG. 19A, such that the piston adjacent end of the second side 2240 of the housing chamber 2205 is lowered with respect to the second side of the housing chamber, causing any air on the second side of the housing chamber to pass upward through the damping fluid into the overflow chamber 2126. While the door closer arrangement may be configured to maintain the door closer in this tilted orientation during operation (e.g., using suitable gearing mechanisms to translate the tilted pinion rotation to a vertical door pivot axis of rotation), in other embodiments, the door closer arrangement may be configured to facilitate periodic decoupling of the pinion from the door to tilt the door closer for collection of any trapped air into the overflow chamber.

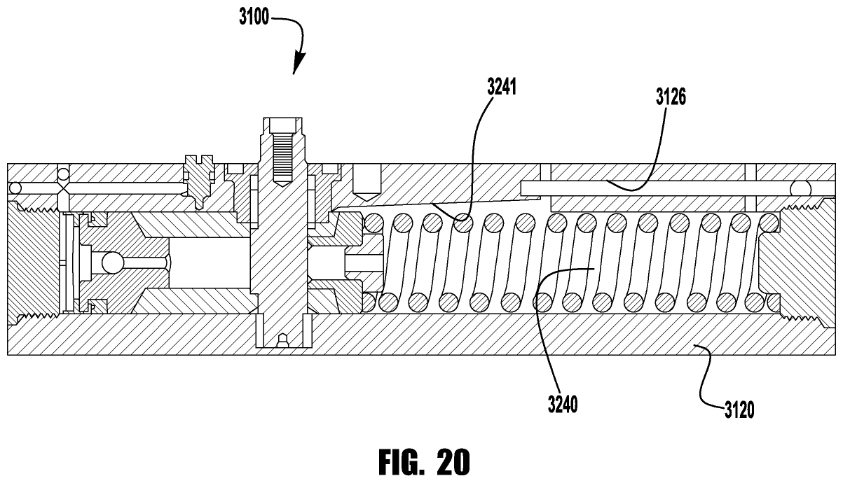

In another embodiment, the second side of the housing chamber may include at least an upper surface portion or feature (e.g., groove, channel, or other feature) extending at an angle upward from horizontal to the air capture chamber, causing air to rise up buoyantly along the angled feature and into the air capture chamber. FIG. 20 illustrates an exemplary closer assembly 3100 including a housing 3120 with a housing chamber including a second side 3240 having an upward angled surface feature 3241 (e.g., groove, channel, or other feature) extending to an air capture chamber 3126 to facilitate passage of air into the air capture chamber.

In other embodiments, a door closer may include a fluid return passage connected with an overflow chamber by a bleed passage, for example, configured to block damping fluid flow while permitting air flow to bleed any trapped air in the fluid return passage through to the overflow chamber. FIG. 21 illustrates a cross-sectional view of an exemplary door closer assembly 4100, including a housing 4120 having a fluid return passage 4250 connected with an air capturing overflow chamber 4126 by a bleed passage 4209, the flow of air through which may, but need not, be independent of any adjustment by the fluid return control device 4220. As shown, the overflow chamber 4126 may include an upper recessed portion 4128 sized and positioned to trap air, preventing recirculation of the trapped air to the first side 4230 of the housing chamber 4205.

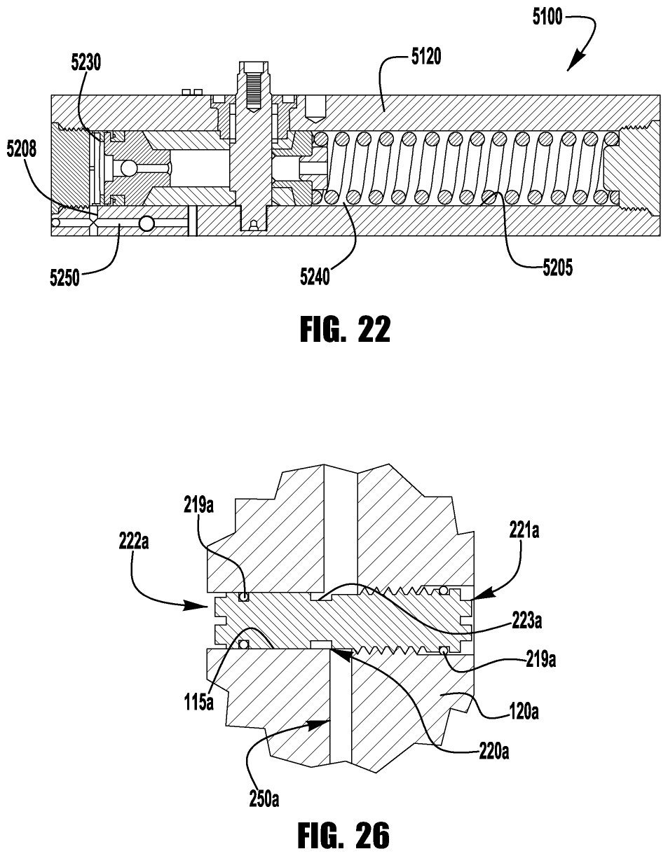

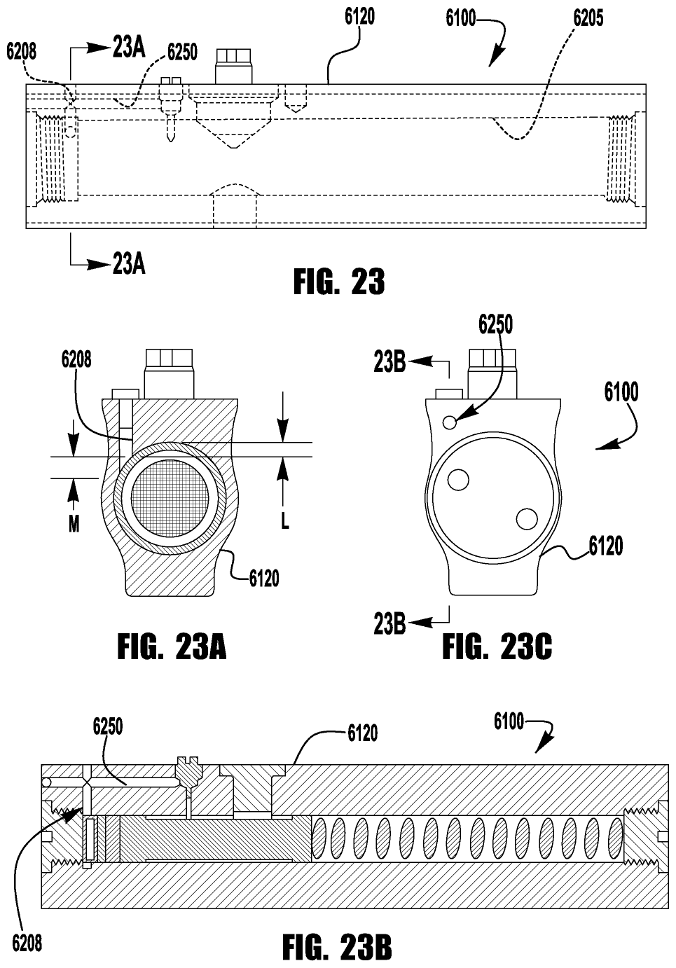

In other embodiments, a door closer may include a fluid return passage arranged to be connected with the second side of the housing chamber by a connecting passage at a location below a minimum expected level of any trapped air within the second side of the housing chamber, to prevent the ingress of trapped air into the fluid return passage. Many different configurations may be used to provide a lower fluid return passage connection. For example, FIG. 22 illustrates a closer assembly 5100 including a housing 5120 having a fluid return passage 5250 disposed below the housing chamber 5205, with a connecting passage 5208 connecting the fluid return passage to a lower portion of the first side 5230 of the housing chamber. As another example, FIGS. 23, 23A, 23B, and 23C illustrate a closer assembly 6100 including a housing 6120 having a fluid return passage 6250 disposed above the housing chamber 6205, with a connecting passage 6208 connecting the fluid return passage to a lower middle or medial portion M of the first side 6230 of the housing chamber, below a minimum expected level L of any trapped air within the housing chamber.

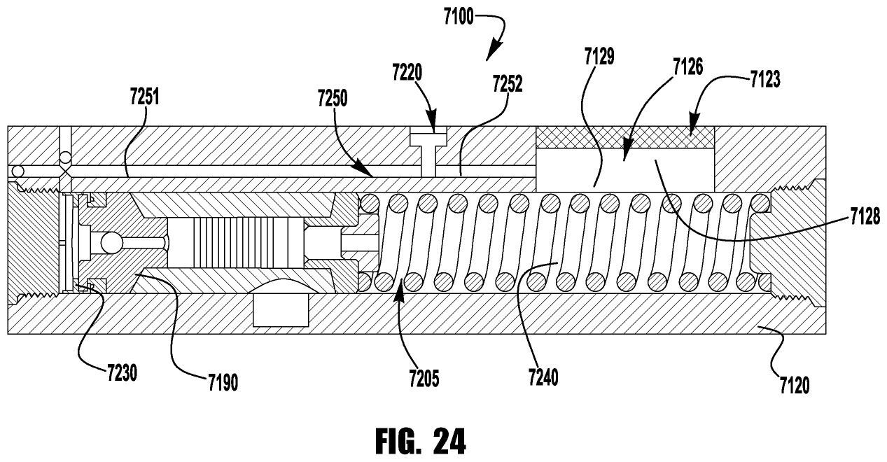

In other embodiments, a closer assembly may be provided with a fluid return passage that connects directly with an overflow chamber in communication with or integrally formed with the second side of the housing chamber. An upper portion of the overflow chamber is sized and positioned to capture air passing through the fluid return passage, and a lower portion of the overflow chamber extends to the second side of the housing chamber for return of the damping fluid. FIG. 24 illustrates an exemplary closer assembly 7100 including a housing 7120 having a fluid return passage 7250 including a first portion 7251 connected with the first side 7230 of the housing chamber 7205, and a second portion 7252 (separated from the first portion by a fluid control device 7220) extending directly to an overflow chamber 7126 open to, and disposed above, the second side 7240 of the housing chamber 7205. The overflow chamber 7126 includes an upper portion 7128 sized to receive and retain trapped air, and a lower portion 7129 extending to the second side 7240 of the housing chamber 7205 for return of the damping fluid during spring return movement of the piston 7190 (e.g., door closing movement). As shown, the overflow chamber 7126 may be externally sealed by a plug 7123 or other such structure assembled with or integrated with the housing 7120.

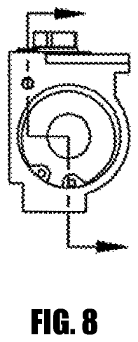

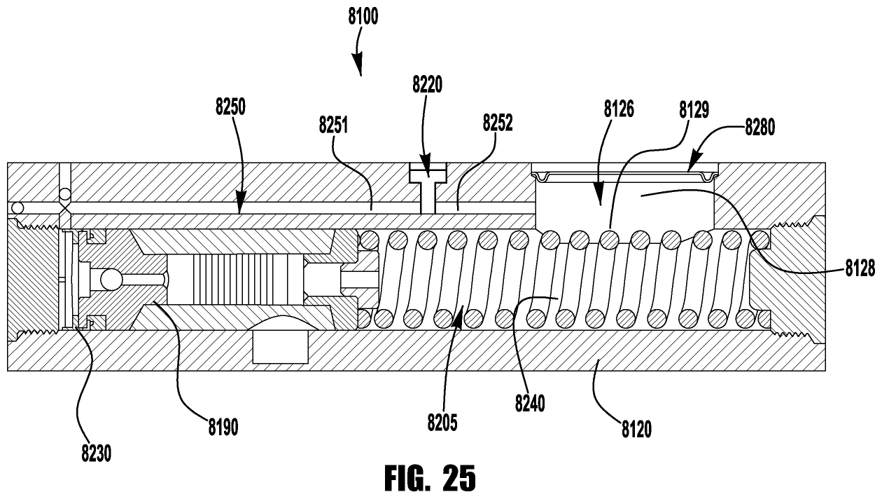

According to another aspect of the present disclosure, in other embodiments, an overflow chamber directly connected with a fluid return passage may be provided with a pressure displaceable element to provide a variable volume for expansion of damping fluid, similar to the embodiments of FIGS. 1-18C. FIG. 25 illustrates an exemplary closer assembly 8100 including a housing 8120 having a fluid return passage 8250 including a first portion 8251 connected with the first side 8230 of the housing chamber 8205, and a second portion 8252 (separated from the first portion by a fluid control device 8220) extending directly to an overflow chamber 8126 open to, and disposed above, the second side 8240 of the housing chamber 8205. The overflow chamber 8126 includes an upper portion 8128 sized to receive and retain trapped air, and a lower portion 8129 extending to the second side 8240 of the housing chamber 8205 for return of the damping fluid during spring return movement of the piston 8190 (e.g., door closing movement). As shown, the overflow chamber 8126 is provided with a flexible partition 8280, which may, but need not, be similar to the flexible partition 1280 shown in FIGS. 17-18C and described above, providing for outward deflection and a net volume increase when the damping fluid in the housing chamber 8205 expands (e.g., due to temperature increases), and inward deflection and a net volume decrease when the damping fluid in the housing chamber contracts.

Still other features and elements may additionally or alternatively be provided in a fluid damping closer assembly, such as, for example, any one or more of the exemplary assemblies described herein. As one example, a damping actuator assembly may be provided with a two-sided fluid return valve configured for user actuation from either side of the housing, for example, to facilitate use with doors that are hinged on either side edge. FIG. 26 illustrates an exemplary fluid return valve stem 220a assembled with a through bore 115a (and sealed with the bore using gasket seals 219a) in the closer assembly housing 120a, intersecting the fluid return passage 250a. The fluid return valve stem 220a is threadably adjustable by user engagement of either end portion 221a, 222a (e.g., using a screwdriver) to adjust alignment of a grooved portion 223a of the valve stem with the fluid return passage 250a to control flow through the fluid return passage.

In an exemplary embodiment of the present disclosure, a fluid damping apparatus comprises a housing enclosing a chamber retaining a damping fluid; a piston disposed in the housing chamber and movable between a first end position and a second end position; and a variable volume element disposed in the housing chamber having a first size occupying a first volume in the housing chamber. Increased fluid pressure of the damping fluid compresses the variable volume element to a second size occupying a second volume in the housing chamber smaller than the first volume, to permit expansion of the damping fluid, thereby limiting fluid pressure of the damping fluid.

In one such embodiment, the fluid damping apparatus further comprises a biasing spring disposed within the housing chamber to bias the piston toward the second end position.

In one such embodiment, the variable volume element is retained within the biasing spring.

In one such embodiment, contraction of the damping fluid causes the variable volume element to expand to a third size occupying a third volume in the housing larger than the first volume, to maintain a desired fill level of the damping fluid within the housing chamber.

In one such embodiment, the variable volume element defines a sealed enclosure retaining a compressible fluid.

In one such embodiment, the sealed enclosure is outwardly biased by the compressible fluid.

In one such embodiment, the sealed enclosure is outwardly biased by an elastic portion of the variable volume element.

In one such embodiment, the sealed enclosure is outwardly biased by an elastic wall portion of the sealed enclosure.

In one such embodiment, the sealed enclosure comprises a flexible bladder.

In one such embodiment, the sealed enclosure comprises a bellows type enclosure.

In one such embodiment, wherein the sealed enclosure comprises at least one of a flexible metal material, a flexible plastic material, and a flexible elastomeric material.

In one such embodiment, the sealed enclosure comprises a radially expandable enclosure.

In one such embodiment, the sealed enclosure comprises an axially expandable enclosure.

In one such embodiment, the variable volume element comprises a compressible block.

In one such embodiment, the compressible block comprises one of an open cell foam and a closed cell foam.

In one such embodiment, wherein the compressible block includes a fluid sealant coating.

In one such embodiment, the fluid damping apparatus is a door closer assembly.

In one such embodiment, the piston is operatively connected to a pinion for damping connection with a hinged door.

In another exemplary embodiment of the present disclosure, a fluid damping apparatus comprises a housing enclosing a chamber retaining a damping fluid; a piston disposed in the housing chamber and movable between a first end position and a second end position; and a variable volume element disposed in the housing chamber and occupying a first volume in the housing chamber, the variable volume element defining an internal cavity in fluid communication with a vent port in the housing. Increased fluid pressure of the damping fluid compresses the variable volume element to occupy a second volume in the housing chamber smaller than the first volume, to permit expansion of the damping fluid, thereby limiting fluid pressure of the damping fluid.

In one such embodiment, the fluid damping apparatus further comprises a biasing spring disposed within the housing chamber to bias the piston toward the second end position.

In one such embodiment, the variable volume element is retained within the biasing spring.

In one such embodiment, contraction of the damping fluid causes the variable volume element to expand to a third size occupying a third volume in the housing larger than the first volume, to maintain a desired fill level of the damping fluid within the housing chamber.

In one such embodiment, the variable volume element includes an outwardly biased flexible enclosure defining the internal cavity.

In one such embodiment, the flexible enclosure is outwardly biased by an elastic portion of the variable volume element.

In one such embodiment, the flexible enclosure is outwardly biased by an elastic wall portion of the flexible enclosure.

In one such embodiment, the flexible enclosure comprises a radially expandable enclosure.

In one such embodiment, the flexible enclosure comprises an axially expandable enclosure.

In one such embodiment, the flexible enclosure comprises a bellows type enclosure.

In one such embodiment, the flexible enclosure comprises at least one of a flexible metal material, a flexible plastic material, and a flexible elastomeric material.

In one such embodiment, the variable volume element comprises a rigid tube secured in the housing chamber over the vent port in the housing, with an internal piston movable within the tube to define an inner end wall of the cavity.

In one such embodiment, the internal piston is spring biased toward an inner end of the rigid tube.

In one such embodiment, the fluid damping apparatus is a door closer assembly.

In one such embodiment, the piston is operatively connected to a pinion for damping connection with a hinged door.

In another exemplary embodiment of the present disclosure, a fluid damping apparatus comprises a housing enclosing a chamber retaining a damping fluid; a piston disposed in the housing chamber and movable between a first end position and a second end position; and a flexible partition disposed in an opening in the housing intersecting the housing chamber, the flexible partition including an outer periphery fixed to an inner periphery of the opening, and a flexible central portion that is deflectable in response in changes in fluid pressure of the damping fluid. Increased fluid pressure of the damping fluid deflects the central portion of the partition away from the housing chamber to permit expansion of the damping fluid, thereby limiting fluid pressure of the damping fluid.

In one such embodiment, contraction of the damping fluid causes the central portion of the partition to deflect toward the housing chamber to maintain a desired fill level of the damping fluid within the housing chamber.

In one such embodiment, the flexible partition is inwardly biased by an elastic wall portion of the flexible partition.

In one such embodiment, the flexible partition comprises at least one of a flexible metal material, a flexible plastic material, and a flexible elastomeric material.

In one such embodiment, the fluid damping apparatus is a door closer assembly.

In one such embodiment, the piston is operatively connected to a pinion for damping connection with a hinged door.

In another exemplary embodiment of the present disclosure, in a method of making a fluid damping apparatus, a housing is provided enclosing a housing chamber retaining a piston and a fluid return passage in fluid communication with the housing chamber. The housing chamber and the fluid return passage are filled with a damping fluid at a first temperature below an ambient temperature. The temperature of the damping fluid is increased to the ambient temperature, such that the damping fluid undergoes at least one of thermal expansion into an overflow chamber in fluid communication with the housing chamber, and increased fluid pressure within the housing chamber.

In one such embodiment, the fluid damping apparatus is a door closer assembly.

In one such embodiment, the piston is operatively connected to a pinion for damping connection with a hinged door.

In another exemplary embodiment of the present disclosure, in a method of making a fluid damping apparatus, a housing is provided, including a housing chamber retaining a piston disposed between a first side of the housing chamber and a second side of the housing chamber; a fluid return passage connecting the first side of the housing chamber to the second side of the housing chamber; and an air capture chamber connected to the second side of the housing chamber. The housing chamber and the fluid return passage are filled with a damping fluid. The housing is oriented such that at least an upper portion of the second side of the housing chamber is angled from a horizontal orientation, causing the air to pass upward through the damping fluid into the air capture chamber.

In one such embodiment, the step of orienting the housing such that at least an upper portion of the second side of the housing chamber is angled from the horizontal orientation comprises tilting the housing such that the housing chamber is angled from the horizontal orientation.

In one such embodiment, the step of orienting the housing such that at least an upper portion of the second side of the housing chamber is angled from the horizontal orientation comprises providing the second side of the housing chamber with an upward angled surface feature extending to the air capture chamber.

In one such embodiment, the fluid damping apparatus is a door closer assembly.

In one such embodiment, the piston is operatively connected to a pinion for damping connection with a hinged door.

In another exemplary embodiment of the present disclosure, a fluid damping apparatus comprises a housing including a housing chamber retaining a damping fluid and a piston disposed between a first side of the housing chamber and a second side of the housing chamber; a fluid return passage connecting the first side of the housing chamber to the second side of the housing chamber; and an air capture chamber connected to the second side of the housing chamber. The second side of the housing chamber includes an upward angled surface feature extending to the air capture chamber to facilitate passage of air into the air capture chamber.

In one such embodiment, the fluid return passage includes a fluid return control device for limiting the flow rate of damping fluid to the second side of the housing chamber.

In one such embodiment, the fluid return control device comprises a user adjustable valve.

In one such embodiment, the user adjustable valve comprises a fluid return valve stem that is threadably adjustable by user engagement of either end portion to adjust alignment of a grooved portion of the valve stem with the fluid return passage to control flow through the fluid return passage.

In one such embodiment, the fluid damping apparatus is a door closer assembly.

In one such embodiment, the piston is operatively connected to a pinion for damping connection with a hinged door.

In another exemplary embodiment of the present disclosure, a fluid damping apparatus comprises a housing including a housing chamber retaining a damping fluid and a piston disposed between a first side of the housing chamber and a second side of the housing chamber; a fluid return passage connecting the first side of the housing chamber to the second side of the housing chamber; an air capture chamber connected to the second side of the housing chamber; and a bleed passage connecting the fluid return passage to the air capture chamber, the bleed passage being configured to block damping fluid flow while permitting air flow to bleed any trapped air in the fluid return passage to the air capture chamber.

In one such embodiment, the fluid return passage includes a fluid return control device for limiting the flow rate of damping fluid to the second side of the housing chamber.

In one such embodiment, the fluid return control device comprises a user adjustable valve.

In one such embodiment, the user adjustable valve comprises a fluid return valve stem that is threadably adjustable by user engagement of either end portion to adjust alignment of a grooved portion of the valve stem with the fluid return passage to control flow through the fluid return passage.

In one such embodiment, the fluid damping apparatus is a door closer assembly.

In one such embodiment, the piston is operatively connected to a pinion for damping connection with a hinged door.

In another exemplary embodiment of the present disclosure, a fluid damping apparatus comprises a housing including a housing chamber retaining a damping fluid and a piston disposed between a first side of the housing chamber and a second side of the housing chamber; and a fluid return passage connecting the first side of the housing chamber to the second side of the housing chamber. The fluid return passage is connected with the first side of the housing chamber by a connecting passage at a location below a minimum expected level of any trapped air within the first side of the housing chamber, to prevent the ingress of trapped air into the fluid return passage.

In one such embodiment, the fluid return passage is positioned below the housing chamber.

In one such embodiment, the fluid return passage is positioned above the housing chamber.

In one such embodiment, the fluid return passage includes a fluid return control device for limiting the flow rate of damping fluid to the second side of the housing chamber.

In one such embodiment, the fluid return control device comprises a user adjustable valve.

In one such embodiment, the user adjustable valve comprises a fluid return valve stem that is threadably adjustable by user engagement of either end portion to adjust alignment of a grooved portion of the valve stem with the fluid return passage to control flow through the fluid return passage.

In one such embodiment, the fluid damping apparatus is a door closer assembly.

In one such embodiment, the piston is operatively connected to a pinion for damping connection with a hinged door.

In another exemplary embodiment of the present disclosure, a fluid damping apparatus comprises a housing including a housing chamber retaining a damping fluid and a piston disposed between a first side of the housing chamber and a second side of the housing chamber; an overflow chamber disposed above and in fluid communication with the second side of the housing chamber; and a fluid return passage connecting the first side of the housing chamber to the second side of the housing chamber. The fluid return passage connects directly with the overflow chamber, with an upper portion of the overflow chamber being sized and positioned to capture air passing through the fluid return passage, and a lower portion of the overflow chamber extends to the second side of the housing chamber for return of the damping fluid.

In one such embodiment, the overflow chamber includes a pressure displaceable element configured to provide a variable volume for expansion of the damping fluid.

In one such embodiment, the pressure displaceable element comprises a flexible partition disposed in the overflow chamber, the flexible partition including an outer periphery fixed to an inner periphery of the overflow chamber, and a flexible central portion that is deflectable in response in changes in fluid pressure of the damping fluid.

In one such embodiment, the fluid return passage includes a fluid return control device for limiting the flow rate of damping fluid to the second side of the housing chamber.

In one such embodiment, the fluid return control device comprises a user adjustable valve.

In one such embodiment, the user adjustable valve comprises a fluid return valve stem that is threadably adjustable by user engagement of either end portion to adjust alignment of a grooved portion of the valve stem with the fluid return passage to control flow through the fluid return passage.

In one such embodiment, the fluid damping apparatus is a door closer assembly.

In one such embodiment, the piston is operatively connected to a pinion for damping connection with a hinged door.

While various aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, alternatives as to form, fit and function, and so on--may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

We claim:

1. A fluid damping apparatus comprising:
a housing enclosing a chamber retaining a damping fluid;
a piston disposed in the housing chamber and movable between a first end position and a second end position; and
a variable volume element disposed in the housing chamber having a first size occupying a first volume in the housing chamber;
wherein increased fluid pressure of the damping fluid compresses the variable volume element to a second size occupying a second volume in the housing chamber smaller than the first volume, to permit expansion of the damping fluid, thereby limiting fluid pressure of the damping fluid.

2. The fluid damping apparatus of claim 1, further comprising a biasing spring disposed within the housing chamber to bias the piston toward the second end position.

3. The fluid damping apparatus of claim 2, wherein the variable volume element is retained within the biasing spring.

4. The fluid damping apparatus of claim 1, wherein contraction of the damping fluid causes the variable volume element to expand to a third size occupying a third volume in the housing larger than the first volume, to maintain a desired fill level of the damping fluid within the housing chamber.

5. The fluid damping apparatus of claim 1, wherein the variable volume element defines a sealed enclosure retaining a compressible fluid.

6. The fluid damping apparatus of claim 5, wherein the sealed enclosure is outwardly biased by the compressible fluid.

7. The fluid damping apparatus of claim 5, wherein the sealed enclosure is outwardly biased by an elastic portion of the variable volume element.

8. The fluid damping apparatus of claim 5, wherein the sealed enclosure is outwardly biased by an elastic wall portion of the sealed enclosure.

9. The fluid damping apparatus of claim 5, wherein the sealed enclosure comprises a flexible bladder.

10. The fluid damping apparatus of claim 5, wherein the sealed enclosure comprises a bellows type enclosure.

11. The fluid damping apparatus of claim 5, wherein the sealed enclosure comprises at least one of a flexible metal material, a flexible plastic material, and a flexible elastomeric material.

12. The fluid damping apparatus of claim 5, wherein the sealed enclosure comprises a radially expandable enclosure.

13. The fluid damping apparatus of claim 5, wherein the sealed enclosure comprises an axially expandable enclosure.

14. The fluid damping apparatus of claim 1, wherein the variable volume element comprises a compressible block.

15. The fluid damping apparatus of claim 14, wherein the compressible block comprises one of an open cell foam and a closed cell foam.

16. The fluid damping apparatus of claim 14, wherein the compressible block includes a fluid sealant coating.

17. The fluid damping apparatus of claim 1, wherein the fluid damping apparatus is a door closer assembly.

18. The fluid damping apparatus of claim 17, wherein the piston is operatively connected to a pinion for damping connection with a hinged door.

19. A fluid damping apparatus comprising:
a housing enclosing a chamber retaining a damping fluid;
a piston disposed in the housing chamber and movable between a first end position and a second end position; and
a variable volume element disposed in the housing chamber and occupying a first volume in the housing chamber, the variable volume element defining an internal cavity in fluid communication with a vent port in the housing;
wherein increased fluid pressure of the damping fluid compresses the variable volume element to occupy a second volume in the housing chamber smaller than the first volume, to permit expansion of the damping fluid, thereby limiting fluid pressure of the damping fluid.

20. A fluid damping apparatus comprising:
a housing enclosing a chamber retaining a damping fluid;
a piston disposed in the housing chamber and movable between a first end position and a second end position; and
a flexible partition disposed in an opening in the housing intersecting the housing chamber, the flexible partition including an outer periphery fixed to an inner periphery of the opening, and a flexible central portion that is deflectable in response in changes in fluid pressure of the damping fluid;
wherein increased fluid pressure of the damping fluid deflects the central portion of the partition away from the housing chamber to permit expansion of the damping fluid, thereby limiting fluid pressure of the damping fluid.
